(19) United States
(12) Patent Application Publication
(10) Pub. No.: US 2014/0229301 A1
(43) Pub. Date: Aug. 14, 2014

(54) On-Site Ordering System for Mobile Devices

(71) Applicant: Andy Wu, Lexington, MA (US)

(72) Inventor: Andy Wu, Lexington, MA (US)

(21) Appl. No.: 13/762,838

(22) Filed: Feb. 8, 2013

(51) Int. Cl. G06Q 30/06; G06Q 50/12

(52) U.S. Cl. CPC G06Q 30/0635; G06Q 50/12
USPC 705/15

(57) ABSTRACT

The present invention relates to an ordering system that allows a mobile device to connect to the ordering system through an on-site wireless network access device and to place orders. A mobile device, such as a smartphone or a tablet, is connected to a service provider's wireless network access point to confirm the customer is physically on-site. The ordering system provides an ordering interface to the web browser running on the mobile device. A customer enters his order through the ordering interface on the mobile device. The order is sent back to the ordering system for processing. The ordering system processes the received order and sends status notifications to the mobile device to notify the customer that his order is ready.

### TECHNICAL FIELD

The present invention relates to an ordering system with which a mobile device connects through an on-site network access device.

### BACKGROUND

At a fast service restaurant or a coffee shop, a server takes an order from a customer either face-to-face or through a voice communication system at a drive-through window. The server needs to greet the customer and inquire which food items the customer would like to order. The server may have to wait as the customer needs time to read, understand, and decide between the menu items. Often at a drive-through window, after all items are entered in the ordering system by the server, the server is required to repeat the entire order to the customer to make sure the order is correctly entered. If a mistake is made, the server needs to correct the mistake and repeat the confirmation process. After the order is confirmed and entered in the ordering system, the restaurant prepares the ordered items and delivers them to the waiting customer. During peak hours, customers may need to wait in line just to place an order. Long wait time frustrates customers and may result in lost business. If the restaurant hires more workers to take and process orders from customers during peak hours, while customers' wait time is reduced, the restaurant's labor cost is not.

Some restaurants offer online ordering for take-out or eat-in services through a website. Such website may be provided by the restaurant or a third party online ordering service provider. To place an order, a customer needs to connect his web browser to the restaurant's website using the Internet. Once connected to the website, the customer is normally required to go through a registration process and create a user account by providing his personal information, such as name, address, phone number, email address and credit card information. If the customer already has a user account, he will need to sign in to the account by providing the user name and password. Even though the website has the customer's personal information, such as his home address, his current physical location is unknown to the service provider or the restaurant. If the restaurant has multiple locations, the customer has to go through a list of locations and find out which location he should use. Different menus may be available at different locations, which adds more complications to the ordering process and creates more risks for mistakes. When receiving an order from such online ordering system, the restaurant lacks information to prioritize the received orders. For example, the restaurant may be unable to determine when the food should be ready for the customer. The restaurant has no idea if the customer is close by and ready to pick up since the customer's current location and arrival time is unknown. Even if the customer is physically inside the selected restaurant location, the ordering website has no way of knowing it. If the food is prepared too early, the taste and quality of the food will suffer when it is not served promptly. If the food is prepared too late, the customer will have to wait for a period of time which could have been avoided.

Some methods use GPS (global positioning system) to determine a customer's physical location. Such methods require a customer to use a GPS device to acquire his current geographic location, and to supply his location to the service provider's ordering system. The customer needs to update the ordering system in real time with his geographic location and the ordering system needs to use some sort of mapping service to determine if the customer is at or near a certain location. The GPS device works properly only when the customer is outside a building and has unobstructed access to the GPS satellite. The GPS device may fail when the signal is blocked, like when used inside a building. Thus, the GPS methods are not practical in many cases because most restaurants are indoors. Additionally, multiple restaurants may be located within a relatively small area, such as a mall food court, and most GPS devices do not have the resolution required to distinguish between two closely situated locations.

Some service providers offer a custom application for certain types of mobile devices. The application needs to be downloaded and installed on a customer's mobile device. The application can only work with the service provider who has supplied the application. Separate applications are needed for different service providers. A service provider needs to develop multiple custom applications to support different types of mobile devices, such as the iOS based Apple iPhone and Android based phones. The customer's physical location is normally unknown to the service provider when an order is placed. The above described issues related to unknown customer locations still remain with this type of methods.

### SUMMARY

This summary is provided to introduce a selection of concepts in a simplified form that are further described below in the Detailed Description. This summary is not intended to identify key features of the claimed subject matter, nor is it intended to be used in determining the scope of the claimed subject matter.

The present disclosure is directed to a system and corresponding methods that facilitate on-site ordering of services by a mobile device connected to a local network access point. A mobile device, such as a smartphone or a tablet, connecting to a service provider's wireless network access device is used as an indication that the customer is physically on-site. An ordering application provides an ordering interface to the mobile device. A customer enters his order through the ordering interface using the mobile device. The order is processed by the ordering application. The ordering system may send status notifications to the customer's mobile device to inform the customer whether his order is ready.

### DESCRIPTION OF THE DRAWINGS

The foregoing aspects and many attendant advantages of this invention will become more readily appreciated through reference to the following detailed description when taken in conjunction with the accompanying drawings.

FIG. 1 illustrates an exemplary system comprising a local wireless network access device, a mobile device, and an ordering application that provides an ordering interface for receiving orders and processing the received orders.

FIG. 2 illustrates another exemplary system comprising a local wireless network access device with a built-in ordering application.

FIG. 3 is a flowchart illustrating an exemplary on-site ordering method.

FIG. 4 illustrates an exemplary apparatus configured to implement an on-site ordering system.

### DETAILED DESCRIPTION

Certain specific details are set forth in the following description and drawings to provide a thorough understanding of various embodiments of the invention. Certain well-known details often associated with computing and software technology are not set forth in the following disclosure to avoid unnecessarily obscuring the various embodiments of the invention. Furthermore, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

The present disclosure is directed to a system and corresponding methods that facilitate on-site ordering. A mobile device connected to a local wireless network access device is used to place orders. A mobile device may be, but is not limited to, a device with wireless network communication functions and a web browser application capable of connecting to remote servers. Some typical mobile devices include smartphones, tablet computers, portable audio/video players, and portable computers. A local wireless access device may include wireless access points. In wireless communication, a wireless network access point (AP) is a device that allows wireless devices or mobile devices to connect to a wired network, such as the Internet, using Wi-Fi or other standards. The Wi-Fi standard allows an electronic device to exchange data wirelessly using radio frequency signals within a wireless local area network. A wireless network AP provides high-speed Internet connections to mobile devices located within its coverage area. The Wi-Fi connection described here is exemplary. Other types of wireless connections, such as Bluetooth, can be used as well.

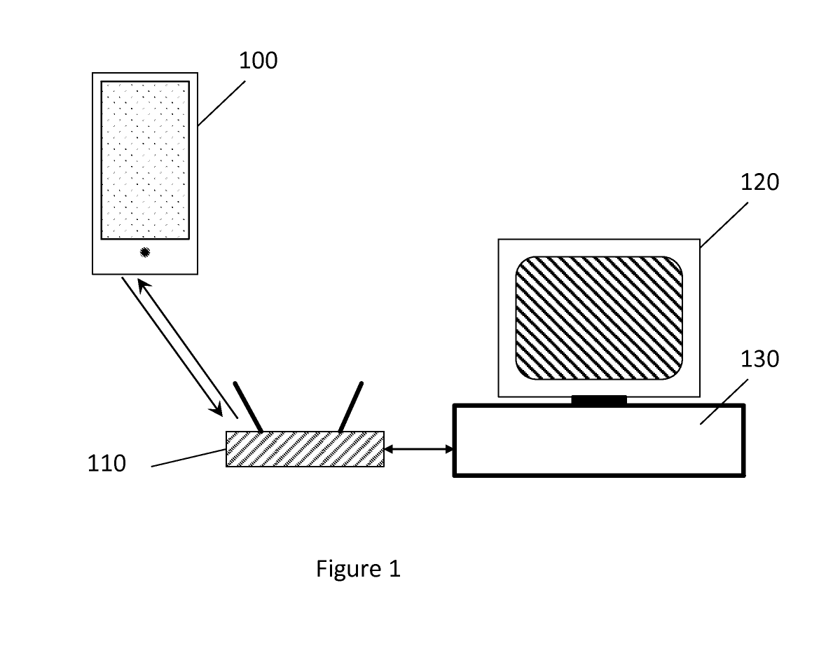

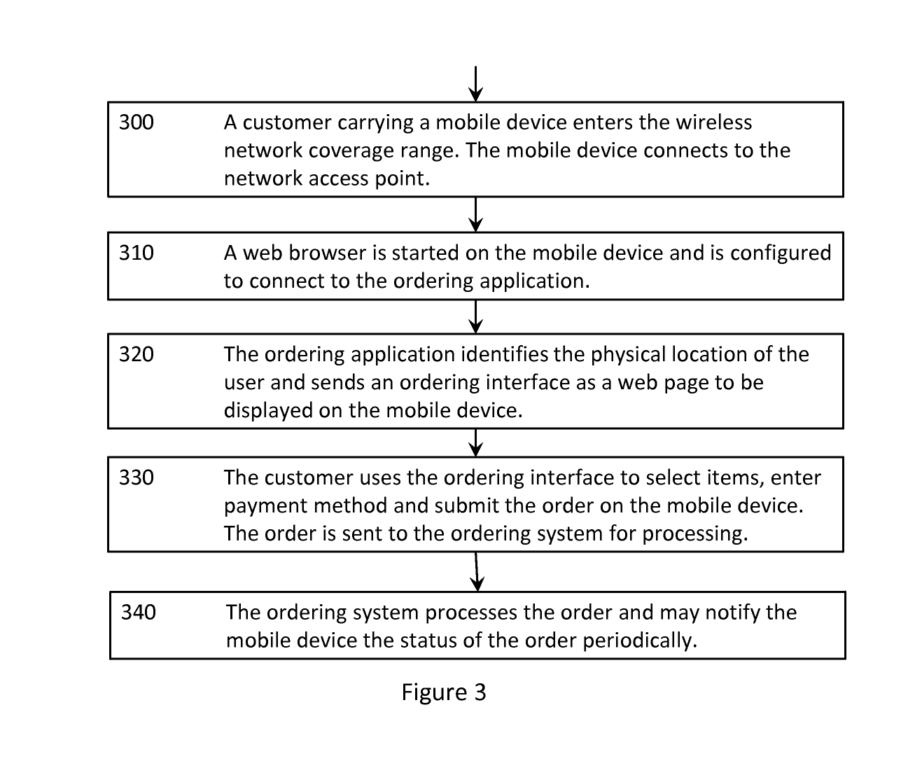

FIG. 1 illustrates an exemplary on-site ordering system including a mobile device 100, a wireless network access device 110, an ordering application 120, and a computer system 130. The ordering application 120 runs on the computer system 130, which is typically a networked computer. The ordering application 120 verifies that the customer's mobile device is connected to the service provider's wireless network through the wireless network access device 110, thus confirms the customer's physical location is on-site. The ordering application 120 provides a user with an ordering interface on his mobile device 100. The ordering application 120 also processes the order received from the user's mobile device 100. More details of the ordering application are illustrated in FIG. 3. In FIG. 1, the mobile device 100 communicates with the wireless network access device 110 through a radio air interface. The wireless network access device 110 is connected to the computer 130 via a cable, e.g., an Ethernet cable, or through a wireless network connection.

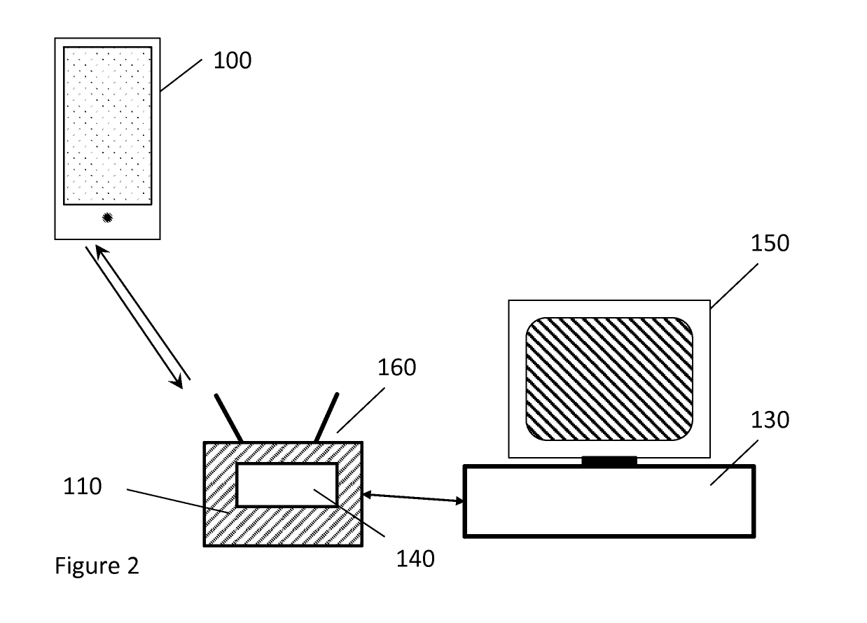

FIG. 2 illustrates another exemplary on-site ordering system including a mobile device 100, a network apparatus 160, an order-processing application 150, and a computer system 130. The network apparatus 160 may be configured to include a wireless network access device 110 with a built-in on-site ordering application 140. The ordering application 140 verifies the physical on-site location of a user's mobile device 100, provides the user with an ordering interface on his mobile device 100, and receives the order from the user. The ordering application 140 also sends the order received from the user's mobile device 100 to the order-processing application 150 to process. The order processing application 150 runs on the computer system 130, which is typically a networked computer. In FIG. 2, the mobile device 100 communicates with the wireless network access device 160 through a radio air interface. The wireless network access device 110 is connected to the computer 130 via a cable, e.g., an Ethernet cable, or through a wireless network connection.

FIG. 3 is a flowchart illustrating an exemplary embodiment of the on-site ordering methods disclosed herein. When a customer carrying a mobile device 100 enters the range covered by the service provider's wireless network access device, e.g., a wireless access point, the mobile device 100 connects to the service provider's wireless network (step 300). The mobile device 100 may be configured to automatically connect to the wireless network. Alternatively the mobile device 100 may present a prompt to the customer to allow the customer to initiate the connection himself. Once the mobile device 100 is connected to the wireless network access device 110, a web browser may be started on the mobile device. The web browser is used to exchange information between the mobile device and the ordering application 120. The web browser may be configured to connect to the ordering application 120 automatically (step 310). The ordering application 120 verifies that the customer's mobile device is connected to the wireless network through the wireless network access device 110, thus confirms the customer's physical location is on-site. The ordering application 120 generates an ordering interface specific to the services provided at the customer's physical location. The ordering application 120 sends the ordering interface to the mobile device 110 in the form of a web page to be displayed in the web browser on the mobile device 100 (step 320). The web browser displays an ordering interface on the mobile device presenting a selection of available items, receives the order entered by the customer, and sends the order to the ordering application 120 for processing. The ordering interface may include a list of selectable items, images or videos of the item(s), background music, or additional information to help make the ordering process simple and easy to use. The customer uses the ordering interface displayed in the web browser on his mobile device to select one or more items, enter his preferred payment method and submit the order. The order is sent to the ordering application 120 for processing (step 330). The ordering application 120 processes the customer's order, and optionally sends notifications periodically to the customer's mobile device regarding the status of the order (step 340).

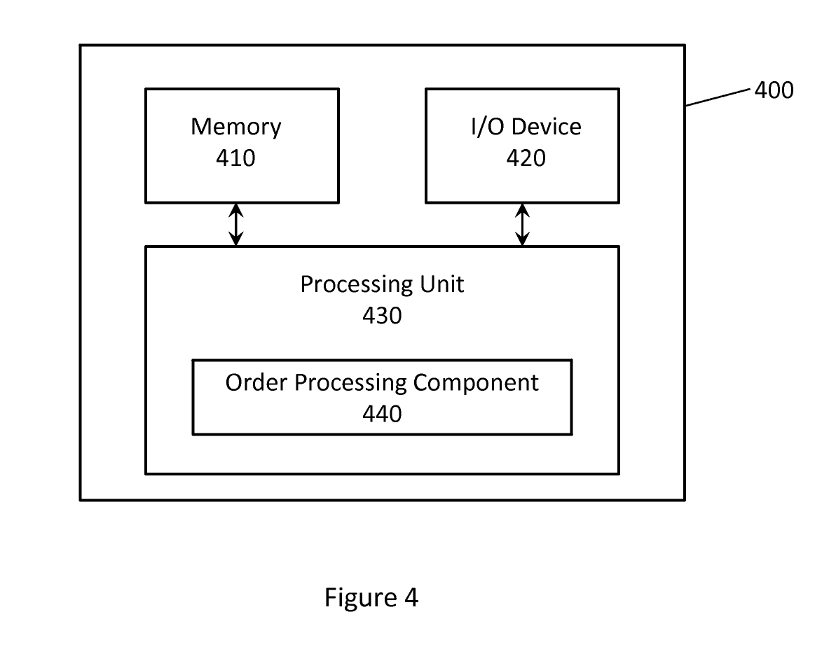

FIG. 4 illustrates an exemplary apparatus 400 suitable for implementing the ordering application 120. The apparatus 400 includes a memory device 410, an I/O device 420, and a processing unit 430. The memory 410 is configured to store data related to order processing and handling. The I/O device 420 is configured to receive user order information from peripherals or network ports, and to output and display processed results. The processing unit 430 is configured to handle order processing and any related computations. The processing unit 430 further comprises an order processing component 440 configured to verify the physical location of the mobile device based on whether the mobile device is connected to the wireless network access device 110, to provide an ordering interface through the web browser on the mobile device, to process the submitted order from the mobile devices, and to send order status notifications to the mobile device.

In some embodiments, the apparatus 400 may further comprise a network connection unit that connects the apparatus 400 to the service provider's network and also provides wireless network access for mobile devices. In such embodiment, the network connection unit performs functions similar to those of a wireless access point.

Although the present invention has been described using specific embodiments, the invention is not limited to these embodiments. Modification within the spirit of the invention will be apparent to those skilled in the art. For example, instead of using a wireless network connection, a wired network connection can perform the same task. Also, a custom application can be used on the customer's mobile device instead of a regular web browser to further simplify the ordering process by automating the network connecting process and utilizing the pre-entered information of the customer, such as payment method.

In the described embodiments, the mobile device may be a device belonging to the customer or supplied by a restaurant or a service provider. To speed up the ordering process, if the mobile device is provided by the restaurant, the mobile device may have already established a network connection with the local network and have the ordering interface on display.

Although the present invention has been described in a restaurant environment, it is not intended that the invention be limited to this environment. This ordering system could be feasibly used at any business or service provider with a point-of-sale ordering system. For example, at an office of the Department of Motor Vehicles (DMV), a customer can connect to the on-site network and fill out personal information and details of her service request on her mobile device to speed up the process and eliminate the waiting line. Notification is sent to her mobile device when she is called up. By then, the customer service representative will have all the relevant information available in a digital form. This will eliminate the need for the customer service representative to hand type the information again, and avoid any possible mistakes.

What is claimed is:

1. A method for handling an order entered by a customer on a mobile device connected to an on-site network access device, comprising the steps of:
detecting that a connection between the mobile device and the on-site network access device is established;
determining a physical location of the mobile device to be on-site based on the established connection;
providing an ordering interface to the mobile device for displaying on the mobile device;
receiving an order from the customer entered through the ordering interface;
processing the received order; and
sending a notification of a status of the order to the mobile device.

2. The method of claim 1, further comprising initiating a web browser on the mobile device, said web browser being connected to the ordering system, wherein the ordering interface is displayed in the web browser.

3. The method of claim 1 wherein determining a physical location of the mobile device to be on-site based on the established connection comprises:
verifying the mobile device is connected to the network through the on-site network access device.

4. A computing device, comprising of:
an input/output device configured to:
receive inputs; and
output information;
a memory device for storing data used by the computing device; and
an order processing circuit configured to:
verify a mobile device is connected through an on-site network access device;
provide an ordering interface to the connected mobile device;
receive an order from the mobile device through the ordering interface; and
process the received order.

5. The computing device of claim 4, wherein the order processing circuit is further configured to notify the mobile device of a status of the order.

6. The computing device of claim 5, wherein the computing device communicates to the connected mobile device to send and receive data.

7. A network apparatus, comprising:
an access device configured to provide wireless network access to mobile devices;
an input/output device configured to:
receive inputs; and
output information;
a memory device for storing data; and
an order processing circuit configured to:
verify a mobile device is connected through the access device;
provide an ordering interface to the connected mobile device;
receive an order from the mobile device through the ordering interface; and
process the received order.

8. The network apparatus of claim 7, wherein the order processing circuit is further configured to send a notification to the mobile device of a status of the received order.

9. The network apparatus of claim 7, wherein the network apparatus communicates to the connected mobile device to send and receive data.
